(19) United States
(12) Patent Application Publication
(10) Pub. No.: US 2010/0322453 A1
(43) Pub. Date: Dec. 23, 2010

(54) CANALPHONES

(75) Inventors: Eiji Matsuyama, Shizuoka (JP); Mitsuhiro Masuda, Shizuoka (JP); Shotaro Kamo, Shizuoka (JP)

Correspondence Address: SUGHRUE-265550, 2100 PENNSYLVANIA AVE. NW, WASHINGTON, DC, 20037-3213, US

(73) Assignee: Star Micronics Co., Ltd., Shizuoka-shi (JP)

(21) Appl. No.: 12/525,849

(22) PCT Filed: Feb. 4, 2008
(86) PCT No.: PCT/JP2008/000134

§ 371 Date: Aug. 5, 2009

(30) Foreign Application Priority Data
Feb. 6, 2007 (JP) 2007-026347

(51) Int. Cl. H04R 25/00

(52) U.S. Cl. 381/380

(57) ABSTRACT

Provided is an insertion type earphone, in which a receiver unit (12) is constituted to have a receiver body (50) (or a BA type receiver) housed in a casing (20). The receiver body (50) includes a housing (56) having a small hole (66a) formed to provide communication between a back space (CR) and the external space. The casing (20) is constituted to include a cylindrical frame (32) having a sound guide tube (16) at its leading end portion and a gasket (36) inserted from a root end portion and fixed in the cylindrical frame (32). The receiver body (50) is so inserted into and fixed in the gasket (36) as to isolate a sound releasing hole (64a) and the small hole (66a). In the gasket (36), a communication hole (36e) is formed to provide communication between the sound releasing hole (64a) and a sound way (16a) of the sound guide tube (16). Between the receiver body (50) and the casing (20), moreover, a back pressure adjusting first closed space (C1) is formed to communicate with the small hole (66a) but isolated from the sound way (16a), thereby to retain the auditory volume feeling in a low sound range sufficiently in the insertion type earphone having the BA type receiver.

### TECHNICAL FIELD

The present invention relates to canalphones and more particularly to the configuration of a receiver unit of the canalphone.

### BACKGROUND ART

Generally, a canalphone includes a receiver unit having a sound conduit and an ear chip attached to the sound conduit of the receiver unit. The canalphone is configured to be used with the ear chip being inserted into an external auditory canal. The receiver unit of the canalphone includes a receiver body and a casing for housing the body.

“Patent Literature 1” discloses a receiver of a balanced armature type (hereinafter, also referred to as “BA receiver”) used as the receiver body of the receiver unit of such canalphone.

The BA receiver is configured to have a diaphragm and a driving unit for vibrating the diaphragm in a housing. In the BA receiver, a front space and a back space are formed on the both sides of the diaphragm, and a sound output port is formed in the housing to provide communication between the front space of the diaphragm and the external space of the receiver body.

Patent literature 1: JP-A-2003-143684

### DISCLOSURE OF THE INVENTION

### Problems that the Invention is to Solve

Ina canalphone using the BA receiver, it is possible to obtain relatively flat frequency characteristics in the low tone range.

In this type of receiver, however, the back space is formed as an enclosed space, hence a listener wearing the canalphones is likely to be unsatisfied with bass volume.

The invention has been conducted in view of these circumstances. It is an object of the invention to provide canalphones of a BA receiver type providing sufficient sound volume in the low tone range satisfactory to the listener wearing the canalphones.

### Means for Solving the Problems

In the invention, the configuration of a receiver unit is improved, thereby attaining the object.

Namely, the canalphone of the invention includes a receiver unit having a sound conduit and an ear chip attached to the sound conduit of the receiver unit. The canalphone is configured to be used with the ear chip inserted into an external auditory canal. In the canalphone, the receiver unit includes a receiver body of a balanced armature type and a casing for the receiver body. The receiver body includes a diaphragm, a driving unit for vibrating the diaphragm, and a housing for the diaphragm and the driving unit. In the housing, a front chamber and a rear chamber are formed on the front and rear sides of the diaphragm. The housing has a sound output port to provide communication between the front chamber of the diaphragm and the external space of the receiver body. The housing further has a small hole to provide communication between the rear chamber of the diaphragm and the external space of the receiver body. The casing includes a tubular frame and a gasket. The sound conduit of the receiver unit is disposed in the leading portion of the tubular frame. The gasket is inserted into the tubular frame from the base portion side of the tubular frame. The gasket has a communicating hole to provide communication between the sound output port and a sound path of the sound conduit. In the canalphone of above configuration, the receiver body is inserted into the gasket and fixed there with the sound output port being isolated from the small hole. The first enclosed space for back pressure adjustment communicating with the small hole is provided between the receiver body and the casing. The first enclosed space is configured to be isolated from the sound path.

The “driving unit” may be placed in the front chamber, or in the rear chamber.

The sectional shape of the “tubular frame” is not particularly restricted and may be a circle, a rectangle, an oval or other as far as the frame is long and hollow like a tube.

The “sound conduit” may be configured by the tubular frame itself, or by another member attached to the tubular frame.

The specific arrangement of the “sound output port” and the “small hole” is not particularly restricted. They may be arranged in any position as far as they are isolated from each other when the receiver body is inserted into the gasket and fixed there.

The “first enclosed space” may be a sealed space. It may be, however, an unsealed space as far as the back pressure can be adjusted. As a specific example of the latter, the space may be configured by a main space formed in the casing at the base portion side with respect to the receiver body, the first communicating path formed between the receiver body and the gasket so as to provide communication between the main space and the small hole, and the second communicating path formed so as to provide communication between the main space and the external space of the casing.

### ADVANTAGES OF THE INVENTION

As shown in the above-described configuration, in the canalphone of the invention, the small hole is formed in the housing of the receiver body to provide communication between the rear chamber of the receiver body and the external space of the receiver body, and the receiver body is inserted into the gasket and fixed there in a manner that the sound output port is isolated from the small hole. Therefore, the elasticity of the rear chamber of the receiver body can be weakened, thereby enabling the diaphragm to be easily vibrated.

In the case where only the small hole is provided, the sound pressure sensitivity is uniformly raised in the low tone range (namely, the frequency range up to the lowest resonance frequency), hence the lowest resonance frequency is shifted toward the low tone side, and the sound pressure level at the lowest resonance frequency is reduced. Therefore, a sharply outlined sound quality cannot be obtained.

In the canalphone of the invention, by contrast, the first enclosed space communicating with the small hole is formed between the receiver body and the casing. The first enclosed space is isolated from the sound path of the sound conduit, hence it serves as an acoustic load for restricting the motion of the diaphragm. According to the configuration, sound pressure sensitivity in the low tone range is raised to some extent, while preventing the shift of the lowest resonance frequency and the reduction of the sound pressure level at the lowest resonance frequency. Therefore, a sharply outlined sound quality can be obtained.

As described above, in the canalphone containing a BA receiver according to the invention, it is possible to provide sufficient sound volume in the low tone range satisfactory to the listener wearing the canalphones. Moreover, this can be realized without affecting the frequency characteristics in the high tone range. Furthermore, the function and effect can be easily obtained without using an electric circuit and simply by adjusting an acoustic element of the receiver unit.

In the configuration, when the first enclosed space is configured by the first main space formed in the casing at the base portion side with respect to the receiver body and the first communicating path formed between the receiver body and the gasket to provide communication between the first main space and the small hole, the sound pressure sensitivity is sufficiently raised in the frequency band less than the predetermined frequency in the low tone range, and the rise of the sound pressure sensitivity is suppressed at the predetermined frequency and over in the low tone range. Therefore, further improved sound quality can be obtained.

In this case, the first communicating path may be adequately adjusted in sectional area and length, thereby adjusting the value of the predetermined frequency to obtain a desired sound quality.

In the above-described configuration, a sound output nozzle surrounding the sound output port is attached to the housing of the receiver body. When the receiver body is inserted into the gasket and fixed there, the sound output nozzle is pressed into the communicating hole of the gasket. According to the configuration, the isolation between the sound output port and the small hole in the receiver body can be performed easily and surely by the press fit of the sound output nozzle to the gasket.

In the configuration, when a second enclosed space for acoustic adjustment communicating with the sound path of the sound conduit is formed between the tubular frame and the gasket, the following function and effect can be obtained.

It is likely in the canalphone that a peak sound pressure is generated at a specific frequency by resonance of the sound conduit. At the specific frequency, the sound is emphasized and the resultant harsh sound would make the listener feel unpleasant.

In order to reduce such a peak sound pressure, an acoustic filter is often disposed in the sound conduit of the canalphone. The acoustic filter is, however, made of a mesh material or the like, hence the sound is likely to be muffled when the volume is turned down.

According to the configuration of the invention, such disadvantage can be eliminated since the second enclosed space can function as a notch filter to remove frequency components generating a peak sound pressure. Therefore, a peak sound pressure could be lowered without requiring an acoustic filter. In the absence of the acoustic filter, a muffled sound in a low volume could be also eliminated.

In the case of this configuration, when the second enclosed space is configured by a second main space formed between an inner circumferential face of the tubular frame and the gasket and a second communicating path formed between an end face of the tubular frame and an end face of the gasket to provide communication between the second main space and the sound path, it is possible to enhance the selectivity of frequency components. Therefore, the function as a notch filter can be enhanced.

In the case of this configuration, an acoustic filter may be further disposed in the sound conduit. When the second enclosed space and the acoustic filter are used in combination in this way, the adverse effect of an acoustic filter can be suppressed, the formation of the second enclosed space is facilitated, and then a peak sound pressure can be reduced.

In the case where an acoustic filter is disposed in this way, the position of the acoustic filter is not particularly restricted. It may be positioned in the leading portion of the sound conduit, the base portion, or the intermediate portion.

In the configuration, even in the case where the small hole is not formed in the housing of the receiver body, when an enclosed space for acoustic adjustment communicating with the sound path is formed between the tubular frame and the gasket, it is possible to enhance the selectivity of frequency components. Therefore, the function as a notch filter can be enhanced.

### BEST MODE FOR CARRYING OUT THE INVENTION

Hereinafter, an embodiment of the invention will be described with reference to the drawings.

FIG. 1 is a side sectional view showing a canalphone 10 of an embodiment of the invention, wherein the canalphone is rightward directed. FIG. 2 is a detail view of the main portions of FIG. 1. FIG. 3 is an exploded perspective view showing the main components of the canalphone 10.

As shown in the figures, the canalphone 10 of the embodiment includes a receiver unit 12 having a sound conduit 16 and an ear chip 14 attached to the sound conduit 16 of the receiver unit 12. The canalphone 10 is used with the ear chip 14 being inserted into an external auditory canal.

The receiver unit 12 has a tubular external shape extending in an anteroposterior direction. The sound conduit 16 is disposed in a front end portion (a right end portion in FIG. 1) of the receiver unit 12.

The receiver unit 12 includes a receiver body 50, a casing 20 for housing the receiver body 50, a spacer 22 and a flexible printed circuit board 24 housed in the casing 20, and a plug cable 26 connected to the receiver body 50 through the flexible printed circuit board 24.

First, the configuration of the receiver body 50 will be described.

FIG. 5 is a side sectional view showing the receiver body 50. The receiver body 50 in FIG. 5 is vertically inverted and then housed in the casing 20.

As shown in the figure, the receiver body 50 is a receiver of a balanced armature type including a diaphragm 52, a driving unit 54 for vibrating the diaphragm, a housing 56 for the diaphragm 52 and the driving unit 54, and a sound output nozzle 58 fixed to the housing 56.

The housing 56 includes a rectangular frame 62 for supporting the diaphragm 52, a top housing 64 fixed to the rectangular frame 62 from above, and a bottom housing 66 fixed to the rectangular frame 62 from below. The housing 56 is of a substantially rectangular parallelepiped external shape.

In the housing 56, a front chamber CF is formed above the diaphragm 52 by the top housing 64, and a rear chamber CR is formed below the diaphragm 52 by the bottom housing 66.

A sound output port 64a is formed in the horizontally middle of the front wall of the top housing 64 to provide communication between the front chamber CF of the diaphragm 52 and the external space of the receiver body 50. The sound output port 64a is a vertical slit.

A small hole 66a is horizontally centered hear the front end of the bottom wall of the bottom housing 66 to provide communication between the rear chamber CR of the diaphragm 52 and the external space of the receiver body 50. The small hole 66a is circular.

The driving unit 54 is housed in the rear chamber CR.

The driving unit 54 includes an armature frame 70 having a horizontally extending strip-like armature 68, a bobbin 72, a pair of vertically arranged magnets 74, a magnetic holder 76, an exciting coil 78, a coupling piece 80 and a pair of horizontally arranged terminals 82.

In the driving unit 54, a DC (direct current) magnetic field ordinarily traverses the gap between the pair of vertically arranged magnets 74. When a signal current is applied to the exciting coil 78, magnetic fluxes corresponding to the signal current are generated in the armature 68 penetrating the exciting coil 78. An AC (alternating current) magnetic field is formed between the armature 68 and the magnets 74 to be superimposed on the DC magnetic field. The vertical force corresponding to the applied signal current is exerted on the armature 68 to make it vertically flexurally deformed. Thereby, the coupling piece 80 fixed to the front end of the armature 68 is vertically displaced as indicated by the arrow in the figure. The displacement of the coupling piece 80 is transmitted to the diaphragm 52 coupled to the upper end portion of the piece 80, whereby the diaphragm 52 is caused to vibrate. Therefore, the receiver body 50 generates a sound wave corresponding to the signal current, and radiates the sound wave to the outside through the sound output port 64a.

The pair of terminals 82 are downward projected through a pair of horizontally arranged through holes (not shown) formed in the vicinity of the rear end of the bottom wall of the bottom housing 66. The terminals 82 are supported by the bobbin 72. The through holes are closed by the lower end of the bobbin 72 pressed into the through holes.

The sound output nozzle 58 is fixed to the front end portion of the housing 56 so as to surround the sound output port 64a. The leading portion 58A of the sound output port 64a is of a tubular shape, and the base portion 58B is formed to be extended to the top housing 64 and the bottom housing 66. The sound output nozzle 58 guides the sound wave radiated from the sound output port 64a to a position near the vertical middle of the front wall of the housing 56, thereby the sound wave is transmitted forward.

Next, the configuration of the casing 20 will be described.

As shown in FIGS. 1 to 3, the casing 20 includes a substantially cylindrical tubular frame 32 having a small-diameter cylindrical portion 32a on the leading portion thereof (i.e., a front end portion), a substantially cylindrical inner tube 34 inserted from the leading side (the front side) and fixed to the small-diameter cylindrical portion 32a, a gasket 36 inserted from the base portion side (i.e., the rear side) of the tubular frame 32 and fixed there, a bottomed cylindrical cap 38 fixed to the base portion of the tubular frame 32, and a cable support 40 attached between the tubular frame 32 and the cap 38. The small-diameter cylindrical portion 32a and the inner tube 34 constitute the sound conduit 16.

The tubular frame 32, the inner tube 34, and the cap 38 are made of a hard material such as aluminum or hard resin. The gasket 36 and the cable support 40 are made of a soft material such as silicone resin or rubber.

The gasket 36 with the bottom wall is substantially cylindrical. The outer diameter of a cylindrical portion 36A of the gasket 36 is set to a value slightly smaller than the inner diameter of the tubular frame 32. On the surface of the gasket 36, a plurality of annular ribs 36a are formed at regular intervals arranged in the anteroposterior direction. In each of the annular ribs 36a, the sectional shape is substantially semi-arcuate, and the maximum diameter (i.e., the diameter at the apex position) is set to a value slightly larger than the inner diameter of the tubular frame 32.

The gasket 36 is pressed into the tubular frame 32 with the end face wall 36B being positioned at the front side. When the gasket 36 is disposed in the tubular frame 32, the annular ribs 36a are slightly compressively deformed, whereby providing a seal between the gasket 36 and the tubular frame 32.

The surface of the cylindrical portion 36A of the gasket 36 is partially cut at the portion near the end face wall 36B, thereby providing a cutout 36b having an arcuate sectional shape of a predetermined length.

The gasket 36 has a receiver-body housing portion 36c of a substantially rectangular sectional shape. The receiver-body housing portion 36c is approximately identical with the housing 56 of the receiver body 50 in sectional shape. The receiver body 50 shown in FIG. 5 is vertically inverted and pressed into the receiver-body housing portion 36c from the base portion side as shown in FIG. 4.

The upper portion of the rear end of the receiver-body housing portion 36c of the gasket 36 is cut out, thereby providing a cutout 36d having an arcuate sectional shape of a predetermined length. Interference with the pair of terminals 82 is thereby avoided.

A communicating hole 36e is formed in a portion slightly below the middle of the end face wall 36B of the gasket 36 to provide communication between the sound output port 64a and a sound path 16a of the sound conduit 16. The communicating hole 36e has an inner diameter slightly smaller than the outer diameter of the leading portion 58A of the sound output nozzle 58 in the receiver body 50. When the receiver body 50 is inserted into the receiver-body housing portion 36c and fixed there, the leading portion 58A of the sound output nozzle 58 is pressed into the communicating hole 36e, and the base portion 58B of the sound output nozzle 58 butts against the end face wall 36B of the gasket 36, whereby the sound output port 64a and the small hole 66a are surely isolated from each other.

A first enclosed space C1 for back pressure adjustment communicating with the small hole 66a is formed between the receiver body 50 and the casing 20. The first enclosed space C1 is configured to be isolated from the sound path 16a.

The first enclosed space C1 includes the first main space C1A formed in the casing 20 at the base portion side with respect to the receiver body 50 and the first communicating path C1B formed between the receiver body 50 and the gasket 36 to provide communication between the first main space C1A and the small hole 66a. The first communicating path C1B is a groove 36f formed at the ceiling of the receiver-body housing portion 36c extending rearward from the leading edge thereof. The sectional shape of the first communicating path C1B is substantially semi-arcuate.

A C-letter shaped rib 36g is formed on the surface of the end face wall 36B of the gasket 36. The sectional shape of the rib 36g is substantially semi-arcuate. The rib 36g is formed along a circle centered on the center axis of the cylindrical portion 36A with the upper part of the rib 36g being cut out. When the gasket 36 is inserted into the tubular frame 32 and fixed there, the rib 36g butts against an end face 32b of the tubular frame 32, thereby a second enclosed space C2 for acoustic adjustment communicating with the sound path 16a of the sound conduit 16 is formed between the tubular frame 32 and the gasket 36.

The second enclosed space C2 includes the second main space C2A formed between the inner circumferential face of the tubular frame 32 and the gasket 36 and the second communicating path C2B formed between the end face of the tubular frame 32 and the end face wall of the gasket 36 to provide communication between the second main space C2A and the sound path 16a.

In the tubular frame 32, the base portion 32c is of a smaller diameter, and a U-shaped groove 32d is formed at the upper and lower parts of the base portion 32c.

The cable support 40 includes an annular portion 40A having the same outer diameter as the tubular frame 32 and a cable housing portion 40B downward extended from the annular portion 40A.

A protrusion 40a having an arcuate sectional shape is formed at the upper and lower parts of the annular portion 40A. Each of the protrusions 40 is configured to be fitted with each of the U-shaped grooves 32d of the tubular frame 32.

The plug cable 26 is supported by the cable housing portion 40B.

In the plug cable 26, a plug (not shown) is attached to the lower end, and a knot 26a is formed near the upper end. The knot 26a is located inside the annular portion 40A. A washer 42 is attached below the knot 26a, butting against the lower protrusion 40a.

A pair of lead wires 26b are extended from the upper end of the plug cable 26. The lead wires 26b are conductively connected to the flexible printed circuit board 24 by soldering.

The flexible printed circuit board 24 is horizontally extended forward. The terminals 82 of the receiver body 50 are conductively connected to the front end portion of the flexible printed circuit board 24 by soldering.

The spacer 22 is configured as an elongated block having a laterally oval sectional shape. The spacer 22 is made of a soft material such as silicone resin or rubber. When the spacer 22 is disposed in the annular portion 40A of the cable support 40, it is slightly elastically compressed and deformed in the anteroposterior direction with the front end butting against the receiver body 50 and the rear end butting against the knot 26a of the plug cable 26. The knot 26a butts against the cap 38, hence the spacer 22 elastically presses the receiver body 50 toward the end face wall 36B of the gasket 36.

The cap 38 is fitted to the annular portion 40A of the cable support 40 to be engaged with the base portion 32c of the tubular frame 32, whereby the first enclosed space C1 is formed in the casing 20.

The inner tube 34 is of a larger diameter near the front end thereof, and has a large-diameter flange 34a formed at the front end. The inner tube 34 is inserted from the front side to the small-diameter cylindrical portion 32a of the tubular frame 32 and fixed there.

An acoustic filter 44 is a disk-shaped member made of a mesh material, nonwoven fabric, or the like of a relatively low acoustic resistance. It is bonded to the flange 34a of the inner tube 34 by an annular double-sided adhesive tape 46.

FIGS. 6 and 7 show the frequency characteristics of the canalphone 10 of the embodiment, especially the relation between the frequency and the sound pressure level.

First, FIG. 6 will be described.

In FIG. 6, the thin solid line is the frequency characteristics of a conventional canalphone having no space corresponding to the first enclosed space C1 for back pressure adjustment and the second enclosed space C2 for acoustic adjustment.

The dash-dot-dash line is the frequency characteristics of a canalphone having no space corresponding to the first enclosed space C1 for back pressure adjustment and the second enclosed space C2 for acoustic adjustment, but having the small hole 66a formed in the housing 56 of the receiver body 50.

The thick solid line is the frequency characteristics of the canalphone 10 of the embodiment, having the space corresponding to the first enclosed space C1 for back pressure adjustment only.

As seen from a comparison of the thin solid line and the dash-dot-dash line, the sound pressure sensitivity in the low tone range is raised when the small hole 66A is formed in the housing 56 of the receiver body 50 as compared with the conventional canalphone. This is because the elasticity of the rear chamber CR is weakened and therefore the diaphragm 52 can be easily vibrated. This thereby provides sufficient sound volume in the low tone range satisfactory to the listener wearing the canalphone. In this case, however, the lowest resonance frequency (specifically, ranging from about 2,000 to 2,500 Hz) is shifted toward the low tone side, and the sound pressure level at the lowest resonance frequency is reduced.

By contrast, as indicated by the thick solid line in FIG. 6, the sound pressure sensitivity in the low tone range is raised to some extent in the canalphone having the first enclosed space C1, preventing the shift of the lowest resonance frequency and the reduction of the sound pressure level. Moreover, the sound pressure sensitivity is sufficiently raised in the frequency band less than the predetermined frequency (particularly ranging from about 200 to 400 Hz) in the low tone range, and the rise of the sound pressure sensitivity is suppressed at the predetermined frequency and over in the low tone range. This thereby provides sufficient sound volume and a sharply outlined sound quality in the low tone range satisfactory to the listener wearing the canalphone.

Next, FIG. 7 will be described.

In FIG. 7, similarly with FIG. 6, the thin solid line shows the frequency characteristics of a conventional canalphone.

The broken line is the frequency characteristics of the canalphone 10 of the embodiment having the space corresponding to the first enclosed space C1 for back pressure adjustment.

In FIG. 7, furthermore, the thick solid line is the frequency characteristics of the canalphone 10 of the embodiment having the both spaces corresponding to the first enclosed space C1 for back pressure adjustment and the second enclosed space for acoustic adjustment.

As shown by the thin solid line or by the broken line, a peak sound pressure is generated at the specific frequency (about 4,500 Hz) in the configuration without the second enclosed space. The peak sound pressure is generated at the specific frequency by resonance of the sound conduit 16. The peak sound pressure level would be higher if the acoustic filter 44 is not provided in the sound conduit 16. In this embodiment, the acoustic filter 44 is disposed, hence the peak value is somewhat suppressed. The acoustic filter 44 is, however, made of a mesh material having a relatively low acoustic resistance, hence providing the acoustic filter 44 is not sufficient to eliminate the peak sound pressure at the specific frequency.

By contrast, as shown by the thick solid line, a peak sound pressure does not appear at the specific frequency in the configuration having the second enclosed space C2. The second enclosed space C2 communicating with the sound path 16a of the sound conduit 16 functions as a notch filter to remove frequency components generating a peak sound pressure at the specific frequency. The peak sound pressure at the specific frequency would emphasize the particular sound, thereby producing unpleasant harsh sounds. In the canalphone of this embodiment, such disadvantage is eliminated.

As described in detail, in the canalphone 10 of the embodiment, the small hole 66a is formed in the housing 56 of the receiver body 50 to provide communication between the rear chamber CR of the receiver body 50 and the external space of the receiver body 50. Since the receiver body 50 is inserted into the gasket 36 and fixed there in a manner that the sound output port 64a is isolated from the small hole 66a, the elasticity of the rear chamber CR can be weakened, thereby enabling the diaphragm 52 to be easily vibrated.

In the canalphone 10 of the embodiment, the first enclosed space C1 communicating with the small hole 66a is formed between the receiver body 50 and the casing 20. The first enclosed space C1 is configured to be isolated from the sound path 16a of the sound conduit 16. Therefore, the first enclosed space C1 can function as an acoustic load for restricting the motion of the diaphragm 52. According to the configuration, sound pressure sensitivity in the low tone range is raised to some extent, preventing the shift of the lowest resonance frequency and the reduction of the sound pressure level at the lowest resonance frequency. Therefore, a sharply outlined sound quality can be obtained.

According to the embodiment, as described above, in the canalphone 10 including the BA receiver, it is possible to provide sufficient sound volume in the low tone range satisfactory to the listener wearing the canalphones. Moreover, this can be realized without affecting the frequency characteristics in the high tone range. Furthermore, the function and effect can be easily obtained without using an electric circuit and simply by adjusting the acoustic elements of the receiver unit 12.

In the embodiment, the first enclosed space C1 is configured by the first main space C1A formed in the casing 20 at the base portion side with respect to the receiver body 50 and the first communicating path C1B formed between the receiver body 50 and the gasket 36 to provide communication between the first main space C1A and the small hole 66a. The sound pressure sensitivity is sufficiently raised in the frequency band less than the predetermined frequency in the low tone range, and the rise of the sound pressure sensitivity is suppressed at the predetermined frequency and over in the low tone range. Therefore, further improved sound quality can be obtained.

In this case, when the sectional area and length of the first communicating path C1B are adequately adjusted, the value of the predetermined frequency can be adjusted. Therefore, a desired sound quality can be easily obtained.

In the embodiment, the sound output nozzle surrounding the sound output port is attached to the housing of the receiver body. When the receiver body is inserted into the gasket and fixed there, the sound output nozzle is pressed into the communicating hole of the gasket. The isolation between the sound output port and the small hole in the receiver body can be performed easily and surely by the press fit of the sound output nozzle to the gasket. Specifically, the communicating hole 36e of the gasket 36 has the inner diameter slightly smaller than the outer diameter of the leading portion 58A of the receiver body 50. When the leading portion 58A of the sound output nozzle 58 is pressed into the communicating hole 36e, the surface of the leading portion 58A closely follows the inner circumferential face of the communicating hole 36e. Therefore, the sound output port 64a and the small hole 66a are surely isolated from each other.

In the embodiment, furthermore, the second enclosed space C2 for acoustic adjustment communicating with the sound path 16a of the sound conduit 16 is formed between the tubular frame 32 and the gasket 33, hence the second enclosed space C2 can function as a notch filter to remove frequency components generating a peak sound pressure. Therefore, a peak sound pressure can be lowered without requiring an acoustic filter.

The canalphone 10 of the embodiment includes the acoustic filter 44 disposed in the sound conduit 16. When the second enclosed space and the acoustic filter are used in combination in this way, the adverse effect (a muffled sound in a low volume) of the acoustic filter can be suppressed, the formation of the second enclosed space is facilitated, and then a peak sound pressure can be reduced.

In this case, the second enclosed space C2 is configured by the second main space C2A formed between the inner circumferential face of the tubular frame 32 and the gasket 36 and the second communicating path C2B formed between the end face of the tubular frame 32 and the end face of the gasket 36 to provide communication between the second main space C2A and the sound path 16a. Therefore, it is possible to enhance the selectivity of frequency components. Consequently, the function as a notch filter can be enhanced.

The canalphone 10 of the embodiment has been described for the configuration having both the first enclosed space C1 for back pressure adjustment and the second enclosed space C2 for acoustic adjustment. Instead, a configuration having only the first enclosed space may be employed. Also in this case, satisfactory sound volume and sound quality is obtained in the low tone range. Instead, a configuration having only the second enclosed space may be employed. Also in this case, the second enclosed space C2 can function as a notch filter to remove frequency components generating a peak sound pressure.

### BRIEF DESCRIPTION OF THE DRAWINGS

FIG. 1 A side sectional view showing a canalphone of an embodiment of the invention.

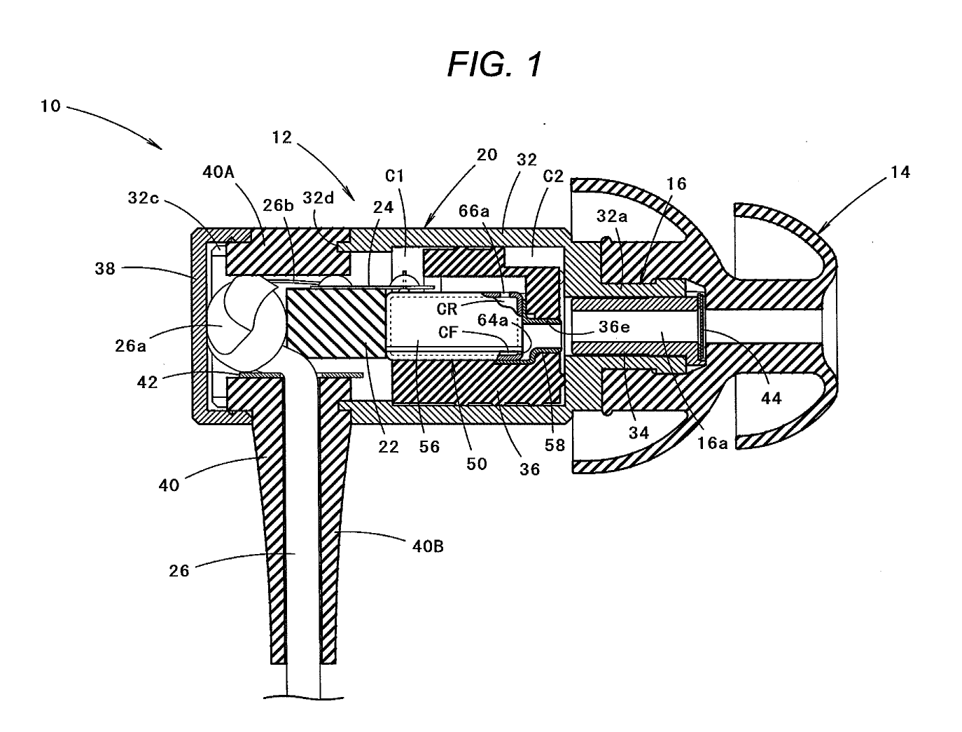

FIG. 2 A detail view of the main portions of FIG. 1.

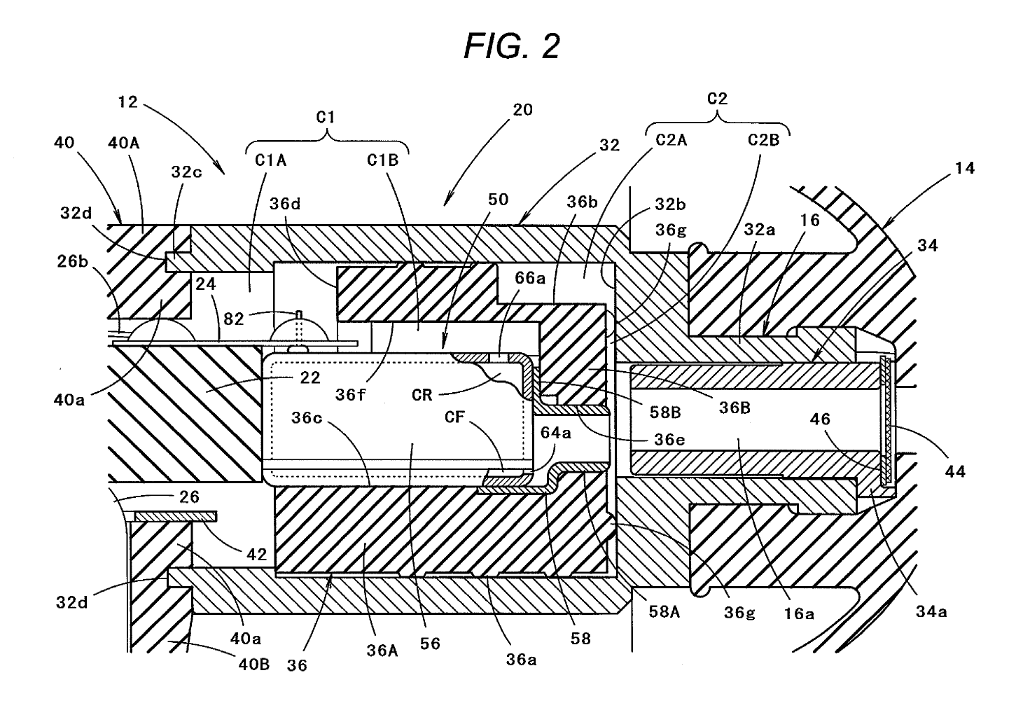

FIG. 3 An exploded perspective view showing the main components of the canalphone.

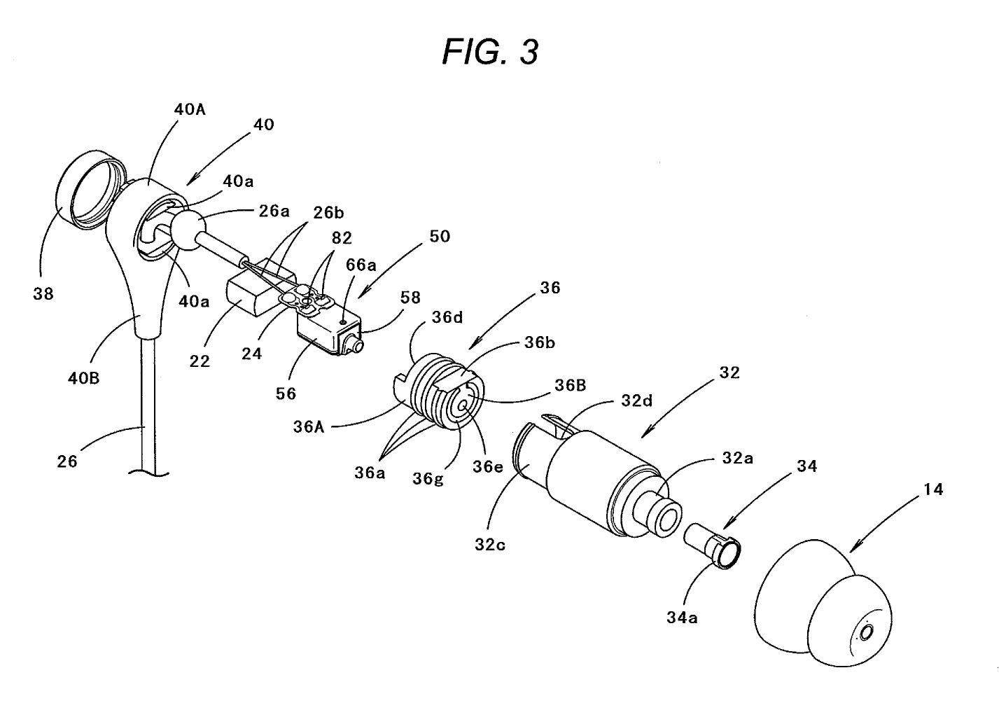

FIG. 4 A perspective view showing the receiver body being inserted into the gasket.

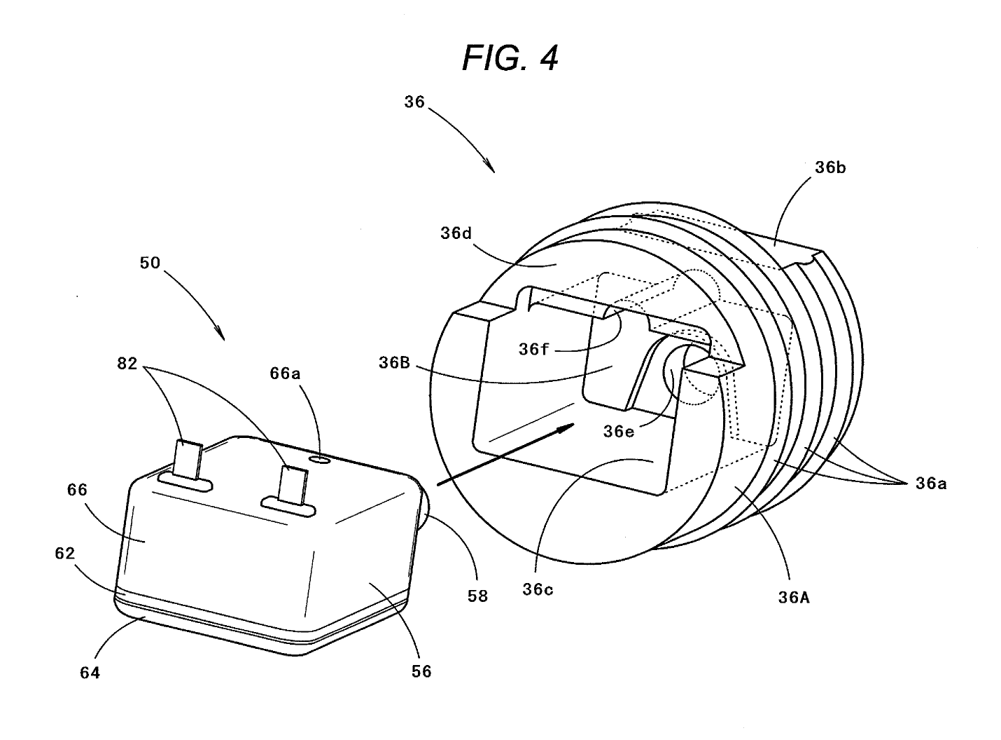

FIG. 5 A side sectional view showing the receiver body.

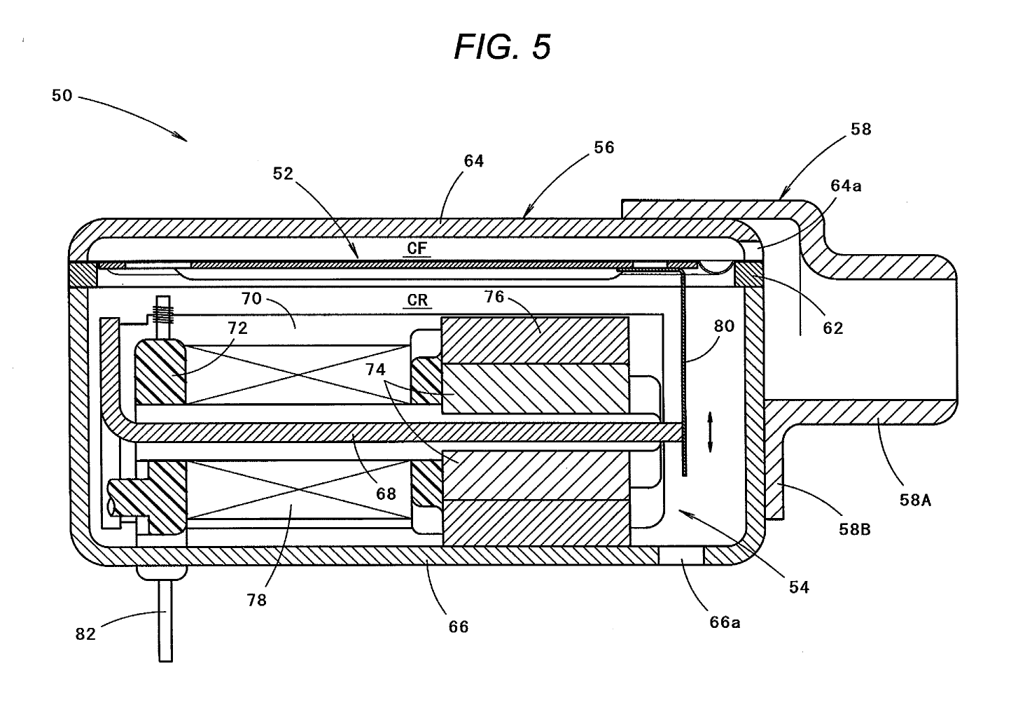

FIG. 6 A comparative graph showing the frequency characteristics of the canalphone of the present invention.

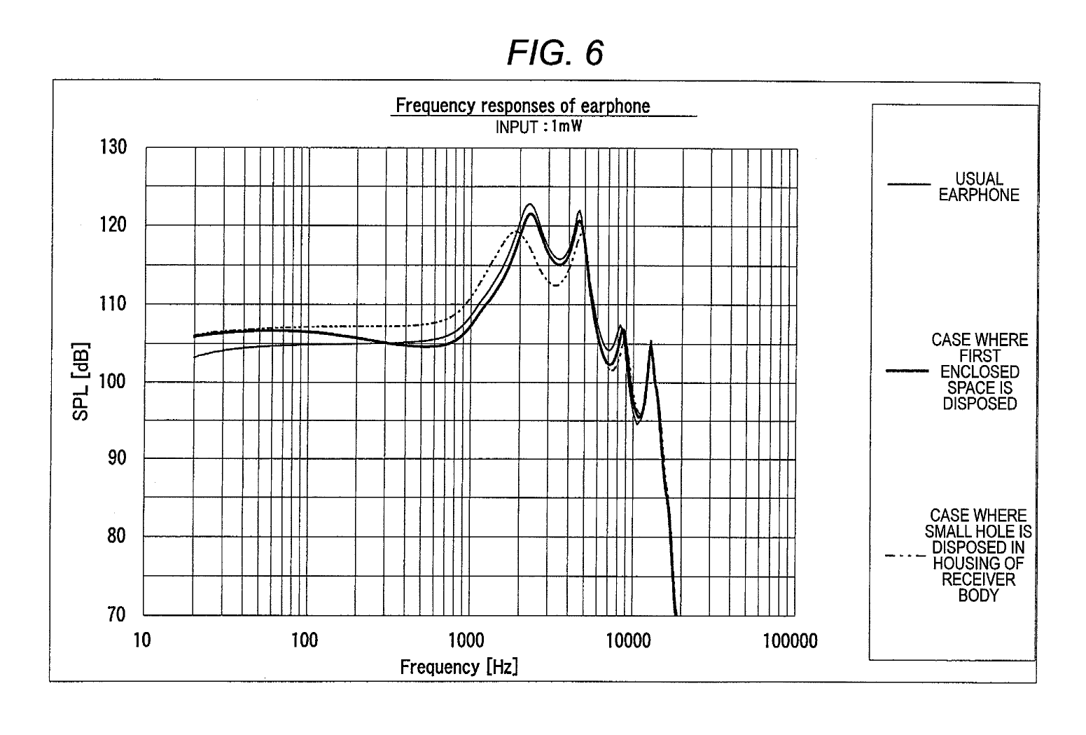

FIG. 7 Another comparative graph showing the frequency characteristics of the canalphone of the present invention.

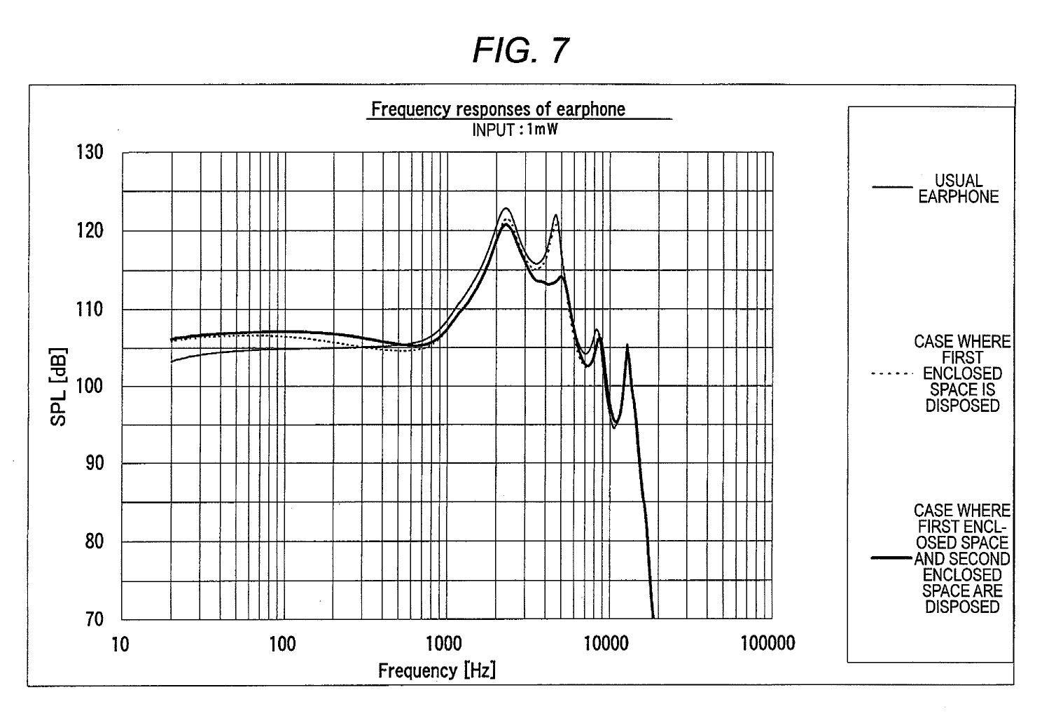

### DESCRIPTION OF REFERENCE NUMERALS AND SIGNS

10 canalphone
12 receiver unit
14 ear chip
16 sound conduit
16a sound path
20 casing
22 spacer
24 flexible printed circuit board
26 plug cable
26a knot
26b lead wire
32 tubular frame
32a small-diameter cylindrical portion
32b end face
32c base portion
32d U-shaped groove
34 inner tube 34a flange portion
36 gasket
36A cylindrical portion
36B end face wall
36a annular rib
36b cutout
36c receiver-body housing portion
36d cutout
36e communicating hole
36f groove
38 cap
40 cable support
40A annular portion
40B cable housing portion
40a protrusion
42 washer
44 acoustic filter
46 double-sided adhesive tape
50 receiver body
52 diaphragm
54 driving unit
56 housing
58 sound output nozzle
58A leading portion
58B base portion
62 rectangular frame
64 top housing
64a sound output port
66 bottom housing
66a small hole
68 armature
70 armature frame
72 bobbin
74 magnet
76 magnetic holder
78 exciting coil
80 coupling piece
82 terminal
CF front chamber
CR rear chamber
C1 first enclosed space
C1A first main space
C1B first communicating path
C2 second enclosed space
C2A second main space
C2B second communicating path

1. A canalphone including a receiver unit having a sound conduit and an ear chip attached to the sound conduit of the receiver unit, the canalphone being used with the ear chip being inserted into an external auditory canal, comprising:
the receiver unit including a receiver body of a balanced armature type and a casing for the receiver body;
the receiver body including a diaphragm, a driving unit for vibrating the diaphragm, and a housing for the diaphragm and the driving unit, the housing including a front chamber and a rear chamber formed on both sides of the diaphragm, the housing further including a sound output port to provide communication between the front chamber of the diaphragm and an external space of the receiver body and a small hole to provide communication between the rear chamber of the diaphragm and the external space of the receiver body;
the casing including a tubular frame and a gasket, the tubular frame including the sound conduit disposed in the leading portion thereof, the gasket being inserted into the tubular frame from the base portion side thereof, the gasket having a communicating hole to provide communication between the sound output port and a sound path of the sound conduit;
wherein the receiver body is disposed in the gasket with the sound output port being isolated from the small hole;
and
a first enclosed space for back pressure adjustment communicating with the small hole is provided between the receiver body and the casing, the first enclosed space being configured to be isolated from the sound path.

2. The canalphone according to claim 1, wherein the first enclosed space comprises a first main space formed in the casing at the base portion side with respect to the receiver body and a first communicating path formed between the receiver body and the gasket to provide communication between the first main space and the small hole.

3. The canalphone according to claim 1 further comprising a sound output nozzle attached to the housing of the receiver body, wherein the sound output nozzle is configured to surround the sound output port and pressed into the communicating hole of the gasket when the receiver body is inserted into the gasket and fixed there.

4. The canalphone according to claim 2 further comprising a sound output nozzle attached to the housing of the receiver body, wherein the sound output nozzle is configured to surround the sound output port and pressed into the communicating hole of the gasket when the receiver body is inserted into the gasket and fixed there.

5. The canalphone according to claim 1 further comprising a second enclosed space for acoustic adjustment provided between the tubular frame and the gasket, wherein the second enclosed space communicates with the sound path.

6. The canalphone according to claim 5, wherein the second enclosed space comprises a second main space formed between an inner circumferential face of the tubular frame and the gasket and a second communicating path formed between an end face of the tubular frame and an end face of the gasket to provide communication between the second main space and the sound path.

7. The canalphone according to claim 6 further comprising an acoustic filter disposed in the sound conduit.

8. The canalphone according to claim 2 further comprising a second enclosed space for acoustic adjustment provided between the tubular frame and the gasket, wherein the second enclosed space communicates with the sound path.

9. The canalphone according to claim 8, wherein the second enclosed space comprises a second main space formed between an inner circumferential face of the tubular frame and the gasket and a second communicating path formed between an end face of the tubular frame and an end face of the gasket to provide communication between the second main space and the sound path.

10. The canalphone according to claim 9 further comprising an acoustic filter disposed in the sound conduit.

11. The canalphone according to claim 3 further comprising a second enclosed space for acoustic adjustment provided between the tubular frame and the gasket, wherein the second enclosed space communicates with the sound path.

12. The canalphone according to claim 11, wherein the second enclosed space comprises a second main space formed between an inner circumferential face of the tubular frame and the gasket and a second communicating path formed between an end face of the tubular frame and an end face of the gasket to provide communication between the second main space and the sound path.

13. The canalphone according to claim 12 further comprising an acoustic filter disposed in the sound conduit.

14. The canalphone according to claim 4 further comprising a second enclosed space for acoustic adjustment provided between the tubular frame and the gasket, wherein the second enclosed space communicates with the sound path.

15. The canalphone according to claim 14, wherein the second enclosed space comprises a second main space formed between an inner circumferential face of the tubular frame and the gasket and a second communicating path formed between an end face of the tubular frame and an end face of the gasket to provide communication between the second main space and the sound path.

16. The canalphone according to claim 15 further comprising an acoustic filter disposed in the sound conduit.

17. A canalphone including a receiver unit having a sound conduit and an ear chip attached to the sound conduit of the receiver unit, the canalphone being used with the ear chip being inserted into an external auditory canal, comprising:
the receiver unit including a receiver body of a balanced armature type and a casing for the receiver body;
the receiver body including a diaphragm, a driving unit for vibrating the diaphragm, and a housing for the diaphragm and the driving unit, the housing including a front chamber and a rear chamber formed on both sides of the diaphragm, the housing further including a sound output port to provide communication between the front chamber of the diaphragm and an external space of the receiver body; and
the casing including a tubular frame and a gasket, the tubular frame including the sound conduit disposed in the leading portion thereof, the gasket being inserted into the tubular frame from the base portion side thereof, the gasket having a communicating hole to provide communication between the sound output port and a sound path of the sound conduit; and
an enclosed space for acoustic adjustment provided between the tubular frame and the gasket, the enclosed space communicating with the sound path.
